(19) United States
(12) Patent Application Publication
(10) Pub. No.: US 2022/0020191 A1
(43) Pub. Date: Jan. 20, 2022

(54) METHOD AND COMPUTER PROGRAM PRODUCT FOR IMAGE STYLE TRANSFER

(71) Applicant: Acer Incorporated, New Taipei City (TW)

(72) Inventors: Shih-Hao LIN, New Taipei City (TW); Chao-Kuang YANG, New Taipei City (TW); Liang-Chi CHEN, New Taipei City (TW); Shu-Wei YEH, New Taipei City (TW)

(21) Appl. No.: 17/308,243

(22) Filed: May 5, 2021

(30) Foreign Application Priority Data
Jul. 15, 2020 (TW) 109123850

(51) Int. Cl. G06T 11/60; G06T 11/00

(52) U.S. Cl. CPC G06T 11/60; G06T 11/001

(57) ABSTRACT

The present application provides a method and a computer program product for image style transfer. The method uses an AI algorithm based on convolution to extract the content representation of a content image and the style representation of a style image, and generate a new image according to the extracted content representation and style representation. This new image not only has both the features of the content image and the features of the style image, but it also more aesthetically pleasing than the images generated by the commonly known methods do.

### CROSS REFERENCE TO RELATED APPLICATIONS

This application claims priority of Taiwan Patent Application No. 109123850, filed on Jul. 15, 2020, the entirety of which is incorporated by reference herein.

### BACKGROUND OF THE INVENTION

### Field of the Invention

The present invention relates to a method and a computer program product for image style transfer, and, in particular, to a method and a computer program product designed based on aesthetics for image style transfer.

### Description of the Related Art

### PRIOR ART DOCUMENT

Gatys, L. A., Ecker, A. S., & Bethge, M. (2015). A neural algorithm of artistic style. arXiv preprint arXiv:1508.06576.

According to the prior art document provided above, image style transfer is the use of an artificial intelligence (AI) algorithm based on convolution to extract the content representation of a content image and the style representation of a style image, and to generate a new image according to the extracted content representation and style representation. This new image has both the features of the content image, such as the shape and the contour of the objects in the content image, as well as the features of the style image, such as the colors and the texture of the style image.

Currently there are a lot of software products or applications using AI to perform image style transfer. However, the effect and the quality of the transfer are not satisfactory. Accordingly, there is a need for a method designed based on aesthetic for image style transfer which can make the style-transferred more aesthetically pleasing.

### BRIEF SUMMARY OF THE INVENTION

The present application discloses a method for image style transfer, including the following steps: inputting a content image and a style image into a second convolutional neural network (CNN) model, whereby the second CNN model extracts a plurality of first feature maps of the content image and a plurality of second feature maps of the style image; inputting the content image into a style-transfer neural network model, whereby the style-transfer neural network model uses a specific number of filters to perform a convolution operation on the content image so as to generate a transferred image; inputting the transferred image into the second CNN model, whereby the second CNN model extracts a plurality of third feature maps of the transferred image; calculating the content loss according to the first feature maps and the third feature maps, and calculating the style loss according to the second feature maps and the third feature maps; adding the product of multiplying the content loss by a content-weight coefficient and the product of multiplying the style loss by a style-weight coefficient together so as to obtain the total loss, wherein the style-weight coefficient is 16 times larger than the content-weight coefficient; using a gradient descent method recursively to optimize the style-transfer neural network model and minimize the total loss so as to obtain an optimum transferred image.

In some embodiments, the content-weight coefficient is 7.5 and the style-weight coefficient is 120.

In some embodiments, the number of filters used by the style-transfer neural network model is 32.

In some embodiments, the method for image style transfer further includes: executing a preprocessing procedure before inputting the style image into the second CNN model to adjust the style image, whereby the blank area occupies 25% of the area of the whole style image.

In some embodiments, the style-weight coefficient is 10000 or above.

The present application also discloses a computer program product for image style transfer, wherein the program is loaded by a computer to perform: a first program instruction, causing a processor to input a content image and a style image into a second convolutional neural network (CNN) model, whereby the second CNN model extracts a plurality of first feature maps of the content image and a plurality of second feature maps of the style image; a second program instruction, causing the processor to input the content image into a style-transfer neural network model, whereby the style-transfer neural network model uses a specific number of filters to perform a convolution operation on the content image so as to generate a transferred image; a third program instruction, causing the processor to input the transferred image into the second CNN model, whereby the second CNN model extracts a plurality of third feature maps of the transferred image; a fourth program instruction, causing the processor to calculate the content loss according to the first feature maps and the third feature maps, and calculating the style loss according to the second feature maps and the third feature maps; a fifth program instruction, causing the processor to add the product of multiplying the content loss by a content-weight coefficient and the product of multiplying the style loss by a style-weight coefficient together so as to obtain the total loss, wherein the style-weight coefficient is 16 times larger than the content-weight coefficient; a sixth program instruction, causing the processor to use a gradient descent method recursively to optimize the style-transfer neural network model and minimize the total loss so as to obtain an optimum transferred image.

In some embodiments of the computer program product disclosed by the present application, the content-weight coefficient is 7.5 and the style-weight coefficient is 120.

In some embodiments of the computer program product disclosed by the present application, the number of filters used by the style-transfer neural network model is 32.

In some embodiments of the computer program product disclosed by the present application, the program is loaded by the computer to further perform a seventh program instruction, causing the processor to execute a preprocessing procedure before inputting the style image into the second CNN model to adjust the style image, whereby the blank area occupies 25% of the area of the whole style image.

In some embodiments of the computer program product disclosed by the present application, the style-weight coefficient is 10000 or above.

### BRIEF DESCRIPTION OF THE DRAWINGS

The patent or application file contains a least one drawing executed in color. Copies of this patent or patent application publication with color drawing(s) will be provided by the Office upon request and payment of the necessary fee. The present invention can be more fully understood by reading the subsequent detailed description and examples with references made to the accompanying drawings, wherein:

FIG. 1 is the schematic diagram 100 of the convolution operation related to the embodiment of the present application.

FIG. 2 is the flow diagram 200 of the method for image style transfer, according to the embodiment of the present application.

FIG. 3 illustrates the relationship between the optimum transferred image and the ratio of the content-weight coefficient to the style-weight coefficient, according to the embodiment of the present application.

FIG. 4 illustrates the effect of the number of filters used by the style-transfer neural network model on the richness of color of the optimum transferred image, according to the embodiment of the present application.

FIG. 5 illustrates the effect of the ratio of the whole style image occupied by the blank area on the texture of the optimum transferred image, according to the embodiment of the present application.

FIG. 6 illustrates thin-film interference effect on the optimum transferred image obtained by configuring the style-weight coefficient β to be 10000 or above, according to the embodiment of the present application.

### DETAILED DESCRIPTION OF THE INVENTION

The present invention relates to a method and a computer program product for image style transfer, which can make the style-transferred images more aesthetically pleasing. The so-called “aesthetic feelings” relates to the conceptual linkage of “aesthetic”, “taste”, “aesthetic perception” and “aesthetic experience”, wherein “aesthetic” indicates the depiction of the target's existing objective natures in the space-time, “taste” indicates the manifested subjective value of the interaction between the viewer subject's soul and the target's natures, “aesthetic perception” indicates the existence of the target's natures perceived by the viewer subject's faculty of perception, and “aesthetic experience” indicates the feelings of perfection and satisfaction induced when the viewer subject contacts the nature of a certain situation or a target.

The existence of aesthetic feelings could be observed, analyzed and experienced in terms of forms of cognition, such as proportion, colors, texture, composition, structure, and construction. The method for image style transfer provided by the present application is designed with emphasis on the aspects of proportion, colors, and textures.

The present application discloses a method for image style transfer. The method may be applied on web interfaces or application programs. In some embodiments, the method for image style transfer disclosed by the present invention may be used with a Web Graphics Library (WebGL) for rendering interactive 2D or 3D graphics within any compatible web browser without the use of plug-ins. For example, users may upload a content image of which style is to be transferred, together with a style image of which style is referenced for the transfer, to a server via a web interface using WebGL. Subsequently, by using the method for image style transfer disclosed by the present application, the server may generate a new image according to the content image and the style image received from the web interface. This new image has both the features of the content image, such as the shape and the contour of the objects in the content image, as well as the features of the style image, such as the colors and the texture of the style image. In another example, users may just upload the content image, and select the style image which has been provided on the web interface.

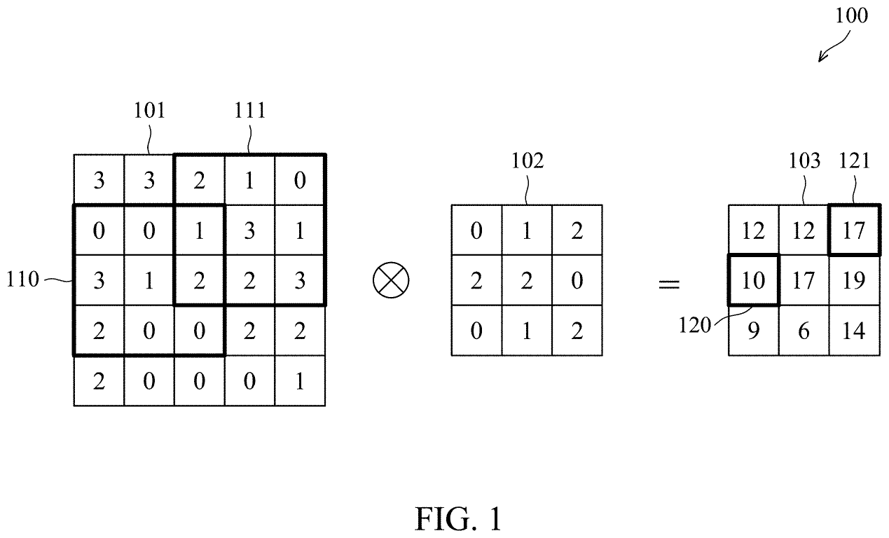

FIG. 1 is the schematic diagram 100 of the convolution operation related to the embodiment of the present application. The schematic diagram 100 includes input image 101, filter 102, and feature map 103, wherein input image 101 has multiple pixels of which pixel values are represented in the form of a matrix (e.g. the 5*5 matrix shown in FIG. 1, but not limited to this). Besides, filter 102 and feature map 103 are also represented in the form of a matrix (e.g. the 3*3 matrix shown in FIG. 1, but not limited to this).

As illustrated in FIG. 1, feature map 103 may be obtained by performing the convolution operation for input image 101 and filter 102. To be specific, the convolution operation is to multiply the pixel values at corresponding positions in filter 102 and input image 101 one by one, and sum up the products of pixel values, to obtain the convolution value (also called “feature point”) at each corresponding position. By repeatedly sliding the position of filter 102 corresponding to input image 101, all the convolution values in feature maps 103 is thereby calculated. For example, by performing the calculation as below for partial matrix 110 in input image 101, we may obtain the result that convolution value 120 in feature map 103 is 10.

0*0+0*1+1*2+3*2+1*2+2*0+2*0+0*1+0*2=10

For another example, by performing the calculation as below for partial matrix 111 in input image 101, we may obtain the result that convolution value 121 in feature map 103 is 17.

2*0+1*1+0*2+1*2+3*2+1*0+2*0+2*1+3*2=17

A convolution neural network (CNN) model may have a plurality of convolution layers, and each convolution layer may have a plurality of filters. The plurality of feature maps obtained by performing the convolution operation as previously described for each convolution layer are then used as the input data for the next convolution layer.

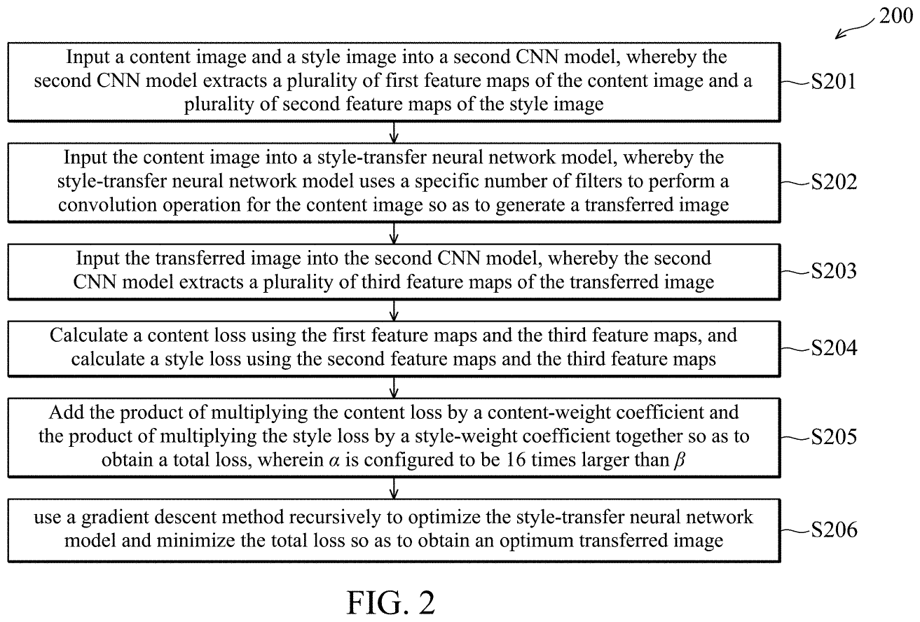

FIG. 2 is the flow diagram 200 of the method for image style transfer, according to the embodiment of the present application. Flow diagram 200 includes steps S201-S206. In step S201, a content image and a style image are input into a second CNN model, whereby the second CNN model extracts a plurality of first feature maps of the content image and a plurality of second feature maps of the style image by performing the convolution operation as previously described. The method then proceeds to S202.

In some embodiments, the second CNN model may be a Visual Geometry Group (VGG) model, such as VGG 16 and VGG 19. In a preferred embodiment, the second CNN model is VGG 19.

In step S202, the content image is input into a style-transfer neural network model, whereby the style-transfer neural network model uses a specific number of filters to perform a convolution operation on the content image so as to generate a transferred image. The method then proceeds to S203.

In some embodiments, the style-transfer neural network model may also be a CNN model, but it is different from the second CNN model. To be specific, in terms of functionality, the style-transfer neural network model is to transfer the input image into a new image using a certain approach. In the subsequent steps, through the training process of repeatedly using the result as feedback and updating the parameters, the new image output by the style-transfer neural network model may thus be converged and optimized gradually. Eventually, the style-transfer neural network model may output an optimum transferred image. In contrast, the second CNN model in the method of this disclosure is to extract the feature maps of the input image, so that the optimization of the style-transfer neural network in the subsequent steps is based on these extracted feature maps. The second CNN model itself is not the one being trained. On the other hand, the style-transfer neural network model may have a different number of convolution layers, a different number of filters, or a different values of items in the filter matrix from the second CNN model.

In step S203, the transferred image is input into the second CNN model, whereby the second CNN model extracts a plurality of third feature maps of the transferred image. The method then proceeds to S204.

In step S204, content loss is calculated using the first feature maps and the third feature maps, and style loss is calculated using the second feature maps and the third feature maps. The method then proceeds to S205.

According to the embodiment of the present application, the content loss may be simply regarded as “the difference between the transferred image and the content image in terms of the content representation (e.g., the shape and the contour of the objects in the images).” To be specific, the content representation indicates the plurality of feature maps output by a selected convolution layer from all the feature maps output by the second CNN model. The calculation of the content loss is as shown by Equation 1 below:

$${L}_{content} ( \vec{p} , \vec{x} , l ) = \frac{1}{2} {\sum }_{i , j} {( {F}_{i , j}^{l} - {P}_{i . j}^{l} )}^{2} \qquad ( Equation 1 )$$

In Equation 1, L_{content} indicates the content loss. \vec{p},\vec{x},l indicate the content image, the transferred image, and the number of layers of the convolution layers respectively. F_{i,j}^{l}, P_{i,j}^{l} indicate the convolution value of a certain feature point in the third feature maps (i.e. the content representation of the transferred image) and the first feature maps (i.e. the content representation of the content image) output by the lth convolution layer respectively.

According to the embodiment of the present application, the style loss may be simply regarded as “the difference between the transferred image and the style image in terms of the style representation (e.g., the colors and the texture).” To be specific, the style representation indicates the correlation between the plurality of feature maps output by each convolution layer, as shown by Equation 2 below:

$${G}_{i , j}^{l} = {\sum }_{k} {F}_{i , k}^{l} {F}_{j , k}^{l} \qquad ( Equation 2 )$$

In Equation 2, G_{i,j}^{l} indicates the style representation obtained from the lth convolution layer and represented in the form of a Gram matrix.

$${\sum }_{k} {F}_{i , k}^{l} {F}_{j , k}^{l}$$

indicates the inner product between each of the plurality of feature maps output by the lth convolution layer. However, in the embodiment of the present application, unlike the calculation of the content loss is based on the content representation obtained from a specific convolution layer, the calculation of the style loss must take the style representations from multiple convolution layers into account, as shown by Equation 3 and Equation 4 below:

$$\begin{matrix}{E}_{l} = \frac{1}{4 {N}_{l}^{2} {M}_{l}^{2}} {\sum }_{i , j} {( {G}_{i , j}^{l} - {A}_{i , j}^{l} )}^{2} & ( Equation 3 ) \\ {L}_{s t y l e} ( \vec{a} , \vec{x} ) = {\sum }_{l = 0}^{L} {w}_{l} {E}_{l} & ( Equation 4 )\end{matrix}$$

In Equation 3 and Equation 4, Eₗ indicates a part of content loss contributed by the lth convolution layer. G_{i,j}^{l} and A_{i,j}^{l} indicate the style representation of the transferred image obtained from the lth convolution layer and the style representation of the style image obtained from the lth convolution layer respectively. Nₗ and Mₗ indicate the number and the size of the plurality of feature maps output by the lth convolution layer respectively. L_{style} indicates the style loss. \vec{a},\vec{x} indicate the style image and the transferred image respectively.

$${\sum }_{l = 0}^{L} {w}_{l} {E}_{l}$$

indicates the weighted sum of each part of style loss contributed by each convolution layer. In the embodiment of the present application, wₗ constantly equals to 1 divided by the number of convolution layers taken into account when calculating the style loss. That is to say that the weight distribution among these convolution layers is uniform. However, the present application is not limited to this.

In step S205, add the product of multiplying the content loss by a content-weight coefficient is added to the product of multiplying the style loss by a style-weight coefficient together, so as to obtain the total loss. The method then proceeds to S206. The calculation of the total loss is also called a “loss function”, as shown by Equation 5 below:

Lₜₒₜₐₗ(\vec{p},\vec{a},\vec{x})=αL_{content}(\vec{p},\vec{x})+βL_{style}(\vec{a},\vec{x}) (Equation 5)

In Equation 5, Lₜₒₜₐₗ indicates the total loss. \vec{p},\vec{a},\vec{x} indicate the content image, the style image, and the transferred image respectively. L_{content} and L_{style} indicate the content loss and the style loss respectively. α and β indicate the content-weight coefficient and the style-weight coefficient respectively. In the embodiment of the present application, α is configured to be 16 times larger than β.

In step S206, a gradient descent method is used recursively to optimize the style-transfer neural network model and to minimize the total loss so as to obtain an optimum transferred image. To be specific, the gradient descent method performs a partial differential operation on the loss function so as to obtain a gradient (i.e., the direction for adjusting the parameters of the style-transfer neural network model). Then, the parameters of the style-transfer neural network model are adjusted to decrease the total loss. Through the training process of repeatedly using the result as feedback and updating the parameters, the total loss may be decreased gradually. When the total loss converges to a minimum value, the transferred image output by the style-transfer neural network model is considered to be an optimum transferred image.

In some embodiments, the gradient descent method used in step S206 may be a Stochastic Gradient Descent (SGD) method or an adaptive movement estimation (Adam) algorithm.

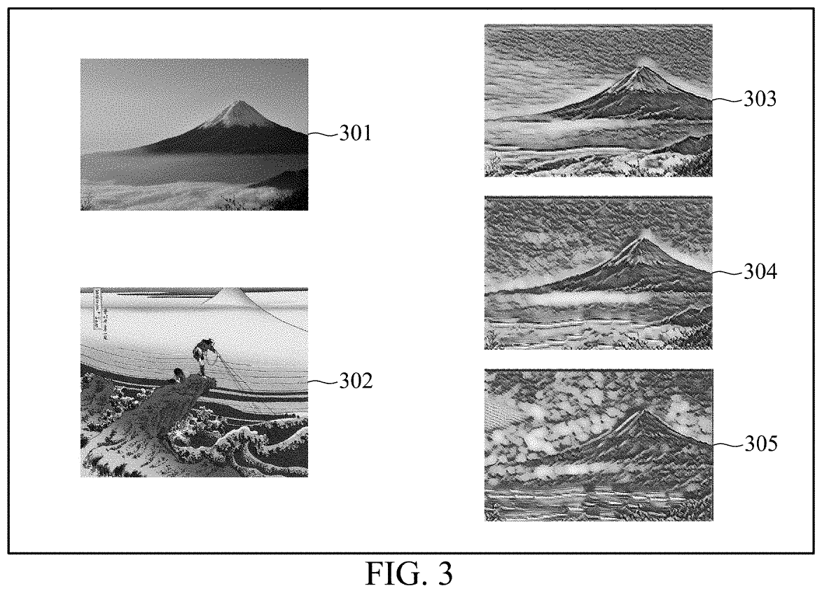

FIG. 3 illustrates the relationship between the optimum transferred image and the ratio of the content-weight coefficient to the style-weight coefficient, according to the embodiment of the present application. In FIG. 3, image 301 and image 302 are a content image and a style image respectively. Image 303, image 304, and image 305 are the optimum transferred images output by the style-transfer neural network model on the condition that α is 10 times larger, 16 times larger, and 27 times larger than β respectively. As shown in FIG. 3, image 303 resembles image 301 (i.e. the content image) more than image 304 and image 305. On the contrary, image 305 resembles image 302 (i.e. the style image) more than image 303 and image 304.

According to the embodiment of the present application, the content-weight coefficient α is 16 times larger than the style-weight coefficient β. This is configured based on the “proportion” aspect of aesthetics. Such configuration not only can avoid the distortion of the optimum transferred image in terms of the content, but also can endow the image with a new style. On this basis, in some embodiments, the content-weight coefficient is configured to be 7.5, and the style-weight coefficient is configured to be 120. As per evaluation by art domain experts, such configuration can certainly make the optimum transferred image output by the style-transfer neural network model more aesthetically pleasing.

According to the embodiment of the present application, in terms of the “colors” aspect of aesthetics, the number of filters used by the style-transfer neural network model may affect the richness of color of the optimum transferred image. Lower number of filters makes the optimum transferred image more monotonous, while higher number of filters makes the optimum transferred image more varicolored. However, as the number of filters used by the style-transfer neural network model increases, performing the image style transfer may also consume more time and thereby impact the user experience. Moreover, the improvement in the richness of color of the optimum transferred image provided by increasing the number of filters may be less obvious when the number of filters is higher.

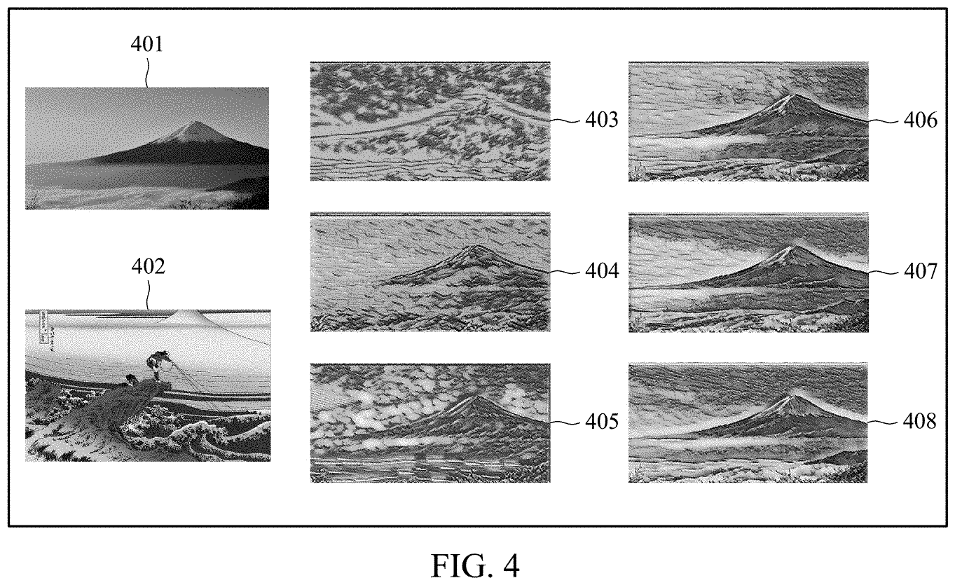

FIG. 4 illustrates the effect of the number of filters used by the style-transfer neural network model on the richness of color of the optimum transferred image, according to the embodiment of the present application. In FIG. 4, image 401 and image 402 are a content image and a style image respectively. Image 403, image 404, image 405, image 406, image 407, and image 408 are the optimum transferred images output by the style-transfer neural network model on the condition that the number of filters used by the style-transfer neural network model is 1, 4, 16, 32, 64, and 128 respectively. As shown in FIG. 4, image 406 is obviously more colorful than image 406, image 404, and image 405. However, there is no obvious change in color between image 406 and image 407, or between image 406 and image 408.

The number of filters used by the style-transfer neural network model is configured to be 32 in this disclosure. As per evaluation by art domain experts, such configuration can certainly make the optimum transferred image more colorful. With regard to the improvement in the richness of color of the optimum transferred image provided by using more than 32 filters, it is not that obvious. Hence, in some embodiments, the number of filters used by the style-transfer neural network model is configured to be 32, so that the user experience and the richness of color of the optimum transferred image is well-balanced.

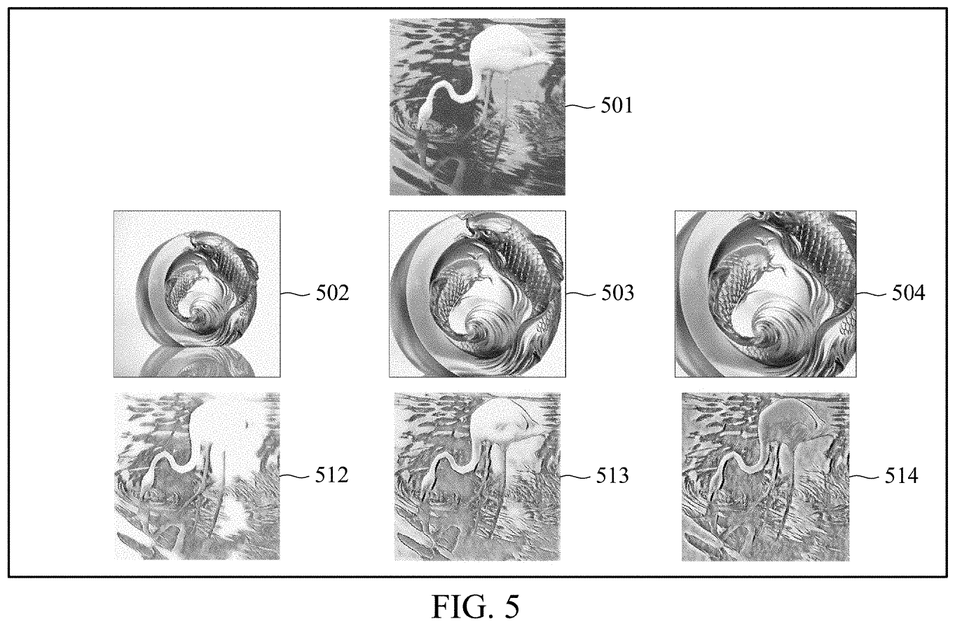

FIG. 5 illustrates the effect of the ratio of the whole style image occupied by the blank area on the texture of the optimum transferred image, according to the embodiment of the present application. In FIG. 5, image 501 is a content image. Image 502, image 503, and image 504 are style images in which the blank area occupies more than 50%, approximately 20%, and approximately 5% of the area of the whole style image, respectively. Image 512, image 513, and image 514 are the optimum transferred images output by the style-transfer neural network model which are corresponding to image 502, image 503, and image 504 respectively. As shown in FIG. 5, the ratio of the whole style image occupied by the blank area obviously affects the optimum transferred image in terms of the “texture” aspect of aesthetics.

According to the embodiment of the present application, as per evaluation by art domain experts, the optimum transferred image is the most aesthetically pleasing when the blank area occupies 25% of the area of the whole style image. Hence, in some embodiments, a preprocessing procedure may be performed before inputting the style image into the second CNN model to adjust the style image, whereby the blank area occupies 25% of the area of the whole style image, so as to obtain the optimum transferred image with the most aesthetic feelings in terms of texture.

In the embodiment of the present application, as stated above, the content-weight coefficient α is 16 times larger than the style-weight coefficient β. On this basis, in some embodiments, configuring the style-weight coefficient to be 10000 or above may make the optimum transferred image output by the style-transfer neural network model enjoy the thin-film interference effect.

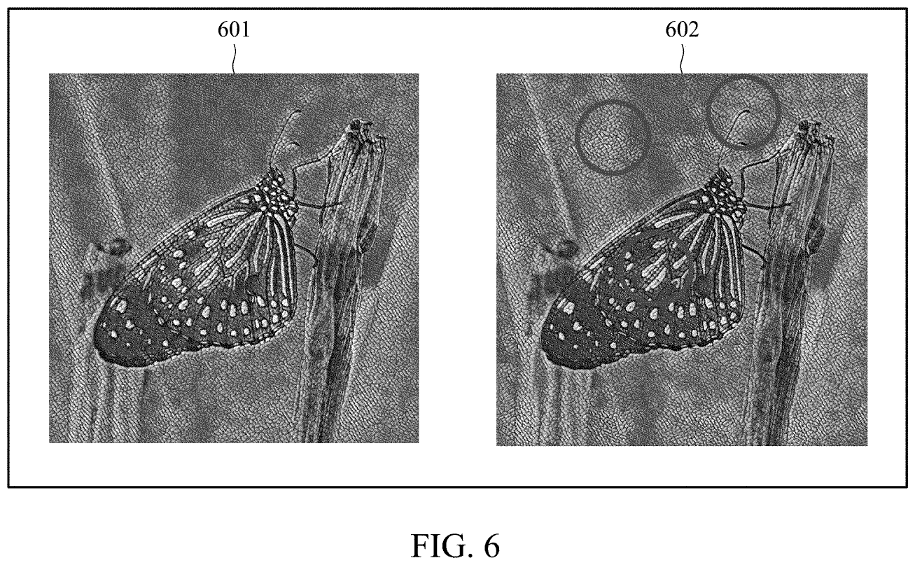

FIG. 6 illustrates thin-film interference effect on the optimum transferred image obtained by configuring the style-weight coefficient β to be 10000 or above, according to the embodiment of the present application. In FIG. 6, image 601 and image 602 are the optimum transferred images output by the style-transfer neural network model when the style-weight coefficient is configured to be 1000 and 10000 respectively. As shown in FIG. 6, image 602 (particularly the three circled area in the image) further has the iridescence as we often see on a soap bubble. This is the thin-film interference effect.

The present application further discloses a computer program product for image style transfer. The program is loaded by a computer to perform a first program instruction, a second program instruction, a third program instruction, a fourth program instruction, a fifth program instruction, and a sixth program instruction, wherein the first program instruction cause the processor to execute S201 in FIG. 2, the second program instruction cause the processor to execute S202 in FIG. 2, the third program instruction cause the processor to execute S203 in FIG. 2, the fourth program instruction cause the processor to execute S204 in FIG. 2, the fifth program instruction cause the processor to execute S205 in FIG. 2, and the sixth program instruction cause the processor to execute S206 in FIG. 2

In some embodiments of the computer program product disclosed by the present application, the content-weight coefficient is configured to be 7.5, and the style-weight coefficient is configured to be 120, so that the optimum transferred image output by the style-transfer neural network model is more aesthetically pleasing.

In some embodiments of the computer program product disclosed by the present application, the number of filters used by the style-transfer neural network model is configured to be 32, so that the user experience and the richness of color of the optimum transferred image is well-balanced.

In some embodiments of the computer program product disclosed by the present application, the program is loaded by the computer to further perform a seventh program instruction, causing the processor to execute a preprocessing procedure before inputting the style image into the second CNN model to adjust the style image, whereby the blank area occupies 25% of the area of the whole style image, so as to obtain the optimum transferred image with the most aesthetic feelings in terms of texture.

In some embodiments of the computer program product disclosed by the present application, configuring the style-weight coefficient to be 10000 or above may make the optimum transferred image output by the style-transfer neural network model enjoy the thin-film interference effect.

The order numbers in the specification and claims, such as “the first”, “the second” and the like, are only for the convenience of describing. There are no chronological relationships between these order numbers.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for image style transfer, comprising the following steps:
inputting a content image and a style image into a second convolutional neural network (CNN) model, whereby the second CNN model extracts a plurality of first feature maps of the content image and a plurality of second feature maps of the style image;
inputting the content image into a style-transfer neural network model, whereby the style-transfer neural network model uses a specific number of filters to perform a convolution operation on the content image so as to generate a transferred image;
inputting the transferred image into the second CNN model, whereby the second CNN model extracts a plurality of third feature maps of the transferred image;
calculating a content loss using the first feature maps and the third feature maps, and calculating a style loss using the second feature maps and the third feature maps;
adding the product of multiplying the content loss by a content-weight coefficient and the product of multiplying the style loss by a style-weight coefficient together so as to obtain a total loss, wherein the style-weight coefficient is 16 times larger than the content-weight coefficient;
using a gradient descent method recursively to optimize the style-transfer neural network model and minimize the total loss so as to obtain an optimum transferred image.

2. The method as claimed in claim 1, wherein the content-weight coefficient is 7.5 and the style-weight coefficient is 120.

3. The method as claimed in claim 1, wherein the specific number is 32.

4. The method as claimed in claim 1, further comprising:
executing a preprocessing procedure before inputting the style image into the second CNN model to adjust the style image, whereby the blank area occupies 25% of an area of the whole style image.

5. The method as claimed in claim 1, wherein the style-weight coefficient is 10000 or above.

6. A computer program product for image style transfer, wherein the program is loaded by a computer to perform:
a first program instruction, causing a processor to input a content image and a style image into a second convolutional neural network (CNN) model, whereby the second CNN model extracts a plurality of first feature maps of the content image and a plurality of second feature maps of the style image;
a second program instruction, causing the processor to input the content image into a style-transfer neural network model, whereby the style-transfer neural network model uses a specific number of filters to perform a convolution operation on the content image so as to generate a transferred image;
a third program instruction, causing the processor to input the transferred image into the second CNN model, whereby the second CNN model extracts a plurality of third feature maps of the transferred image;
a fourth program instruction, causing the processor to calculate a content loss according to the first feature maps and the third feature maps and to calculate a style loss according to the second feature maps and the third feature maps;
a fifth program instruction, causing the processor to add the product of multiplying the content loss by a content-weight coefficient and the product of multiplying the style loss by a style-weight coefficient together so as to obtain a total loss, wherein the style-weight coefficient is 16 times larger than the content-weight coefficient;
a sixth program instruction, causing the processor to use a gradient descent method recursively to optimize the style-transfer neural network model and minimize the total loss so as to obtain an optimum transferred image.

7. The computer program product as claimed in claim 6, wherein the content-weight coefficient is 7.5 and the style-weight coefficient is 120.

8. The computer program product as claimed in claim 6, wherein the specific number is 32.

9. The computer program product as claimed in claim 6, wherein the program is loaded by the computer to further perform a seventh program instruction, causing the processor to execute a preprocessing procedure before inputting the style image into the second CNN model to adjust the style image, whereby the blank area occupies 25% of the area of the whole style image.

10. The computer program product as claimed in claim 6, wherein the style-weight coefficient is 10000 or above.
